(19) United States
(12) Patent Application Publication
(10) Pub. No.: US 2023/0159239 A1
(43) Pub. Date: May 25, 2023

(54) COMBINATION BEVERAGE BOTTLE OPENER AND CAP AND METHOD THEREFOR

(71) Applicant: ANTHONY CLORE, CHANDLER, AZ (US)

(72) Inventor: ANTHONY CLORE, CHANDLER, AZ (US)

(21) Appl. No.: 17/534,077

(22) Filed: Nov. 23, 2021

(51) Int. Cl. B65D 51/24; B67B 7/16; B65D 41/28

(52) U.S. Cl. CPC B65D 51/243; B67B 7/16; B65D 41/28

(57) ABSTRACT

A combination bottle opener and cover has a bottle opening member and a cap. The cap comprises a body member. The body member has a circular groove formed on a bottom surface of the body member. The circular groove has a width “W” equal in size to the width “L” of a lip formed around a top opening in a beverage bottle.

### TECHNICAL FIELD

The present application generally relates to bottled beverages, and, more particularly, to a device to remove a bottle cap from a beverage bottle and to seal an opening formed by the removal of the bottle cap wherein the seal may release gaseous pressure that may build up within the beverage bottle.

### BACKGROUND

Beer, soft drink and other beverages may come in bottles. These beverage bottles may be sealed with a twist-off cap. During manufacturing, once the bottle is filled, a cap is placed on a neck of the bottle and crimped to close. The bottle top may have threads molded thereon. Threads on the cap may be formed by the crimping process thereby sealing the bottle. To open the beverage bottle, one generally twists the cap off Alternatively, one may use a bottle cap opener or other mechanical device such as keys or similar items to lift and remove the cap from the neck of the bottle.

Many bottled beverages, when being served, come with a garnish such as a lemon, lime or other fruit. Many users like to mix the garnish in the bottled beverage. To do so, many users may insert the garnish into the neck of the bottle, place the user's thumb over the open top of the bottle and turn the bottle upside-down and then back right-side up thereby mixing the garnish within the interior of the bottle. Unfortunately, when mixing the garnish inside the bottle, gas molecules in the beverage tend to build-up causing the beverage to foam up and spray out of the top of the bottle. This may create a mess not only on the user's hand but the area where the user I sitting/standing.

Therefore, it would be desirable to provide a device that overcome the above problems. The device would allow a user to cover the opening of a beverage bottle while mixing a garnish within the bottle while gradually releasing pressure after mixing thereby preventing the beverage from flowing out of the top of the bottle.

### SUMMARY

In accordance with one embodiment, a combination bottle opener and cover is disclosed. The combination bottle opener and cover has a bottle opening member. A cap is provided, wherein the cap comprises a body member. The body member has a circular groove formed on a bottom surface of the body member. The circular groove has a width “W” equal in size to the width “L” of a lip formed around a top opening in a beverage bottle.

In accordance with one embodiment, a combination bottle opener and cover is disclosed. The combination bottle opener and cover has a bottle opening member. A cap is coupled to the bottle opening member. The cap has a body member. The body member has a circular groove formed on a bottom surface of the body member. The circular groove has a width “W” equal in size to the width “L” of a lip formed around a top opening in a beverage bottle. The circular groove has a first wall formed around a diameter “D1” of the body member and a second wall formed around a diameter “D2” of the body member wherein the diameter “D1” is larger in size that “D2” forming the circular groove. A “U” shaped indentation is formed around a perimeter of the first wall.

In accordance with one embodiment, a combination bottle opener and cover is disclosed. The combination bottle opener and cover has a bottle opening member. A cap is directly attached to the bottle opening member. The cap is formed of a pliable material and comprises a body member. The body member has a circular groove formed on a bottom surface of the body member. The circular groove having a width “W” equal in size to the width “L” of a lip formed around a top opening in a beverage bottle. The circular groove has a first wall formed around a diameter “D1” of the body member and a second wall formed around a diameter “D2” of the body member wherein the diameter “D1” is larger in size that “D2” forming the circular groove. A “U” shaped indentation is formed around a perimeter of the first wall. The “U” shaped indentation has a depth equal in size to a depth “D” of the lip. The bottle opening member has a leg member which extends out from the cap. A slot is formed at a distal end of the leg member.

### BRIEF DESCRIPTION OF THE DRAWINGS

The present application is farther detailed with respect to the following drawings. These figures are not intended to limit the scope of the present application but rather illustrate certain attributes thereof.

FIG. 1 is a top perspective view of an exemplary embodiment of a bottle top opener and cover in accordance with one aspect of the present application;

FIG. 2 is a bottom view of an exemplary embodiment of the bottle top opener and cover of FIG. 1 in accordance with one aspect of the present application;

FIG. 3 is a cross-sectional view of an exemplary embodiment of the bottle top opener and cover of FIG. 1 in accordance with one aspect of the present application;

FIG. 4 is an exploded view an exemplary embodiment of the bottle top opener and cover of FIG. 1 used with a beverage bottle in accordance with one aspect of the present application;

FIG. 5 is a bottom view of an exemplary embodiment of a bottle top opener and cover in accordance with one aspect of the present application; and

FIG. 6 is a cross-sectional view of an exemplary embodiment of the bottle top opener and cover of FIG. in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure relates to an improved bottle cap opener and cover. The improved bottle cap opener and cover would allow a user to cover the opening of a beverage bottle while mixing a garnish within the beverage bottle and then gradually releasing pressure after mixing thereby preventing the beverage from flowing out of a top opening in the beverage bottle.

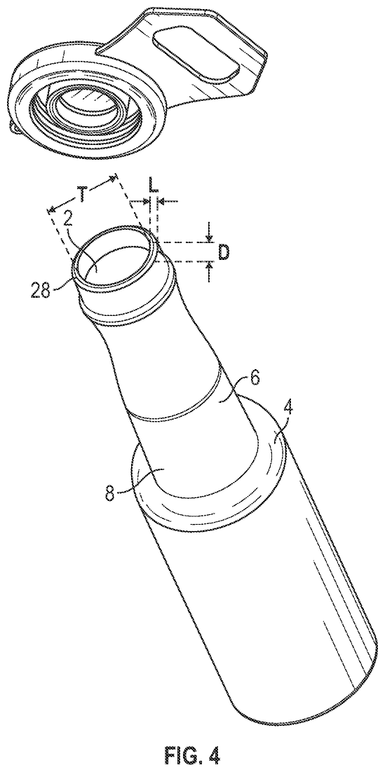

Referring to the FIGS. 1-6, a combination bottle opener and cover 10 may be seen. The bottle opener and cover 10 may be formed of a bottle opening member 12 and a cap 14. The cap 14 may be configured to cover an opening 2 of a beverage bottle 4 while mixing a garnish 6 within the beverage bottle 4 and then gradually releasing pressure that has built up within the beverage bottle 4 during mixing thereby preventing the beverage 8 stored in the beverage bottle from flowing out of a top opening of the beverage bottle.

The cap 14 may be formed of a body member 16. The body member 16 may be sized to have an exterior perimeter which is larger than and covers the opening 2 formed in the top of the beverage bottle 4. In accordance with the present embodiment, the body member 16 may be circular in shape and has a diameter larger than a diameter of the opening 2 in the beverage bottle 4. However, this is given as one example of the shape of the body member 16. The body member 16 may take on other geometric forms without departing from the spirit and scope of the present invention.

The body member 16 may be formed from a soft and pliable material. For example, the body member 16 may be formed of a soft plastic, rubber or similar material. The above are given as examples and should not be seen to be limiting in scope.

Located on a bottom surface 16A of the body member 16 is a bottle sealer 18. The bottle sealer 8 may be designed to be inserted into and cover the opening 2 of the beverage bottle 4. The bottle sealer 18 may have a groove 20 formed within the bottom surface 16A of the body member 16. In accordance with the present embodiment, the groove 20 may be a circular groove 20A. The circular groove 20A may have a width “W” approximately equal in size to the width “L” of a lip 28 formed around the opening 2 in the beverage bottle 4.

The circular groove 20A may form a first wall 22 and a second wall 24. The first wall 22 may be formed around a diameter “D1” of the body member 16 and the second wall 24 may be formed around a diameter “D2” of the body member 16 wherein the diameter “D1” will be larger in size that “D2” thereby forming the circular groove 20A. The first wall 22 may be vertical in nature and have an indentation 26 formed around a perimeter of the first wall 22. The indentation 26 may be a “U” shaped indentation 26A. The “U” shaped indentation 26A may be formed around the perimeter of the first wall 22. The “U” shaped indentation 26A being planer in form along the perimeter of the first wall 22. The “U” shaped indentation 26A may have a depth similar in size to a depth “D” of the lip 28 formed around the top opening in the beverage bottle.

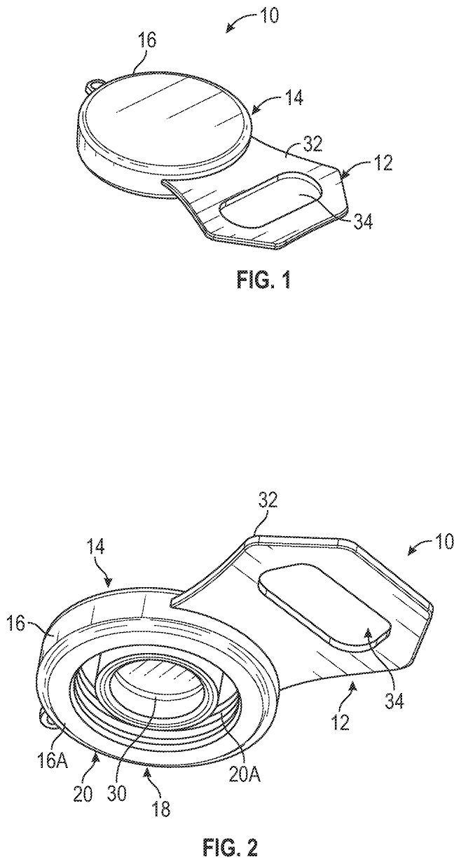

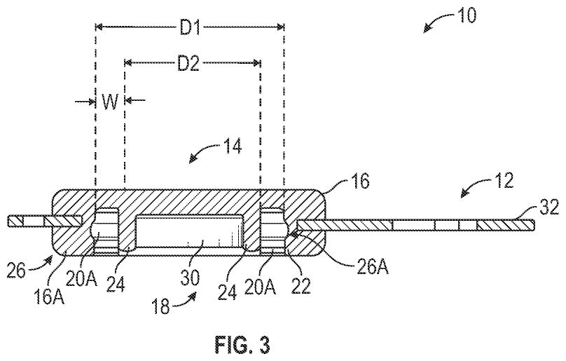

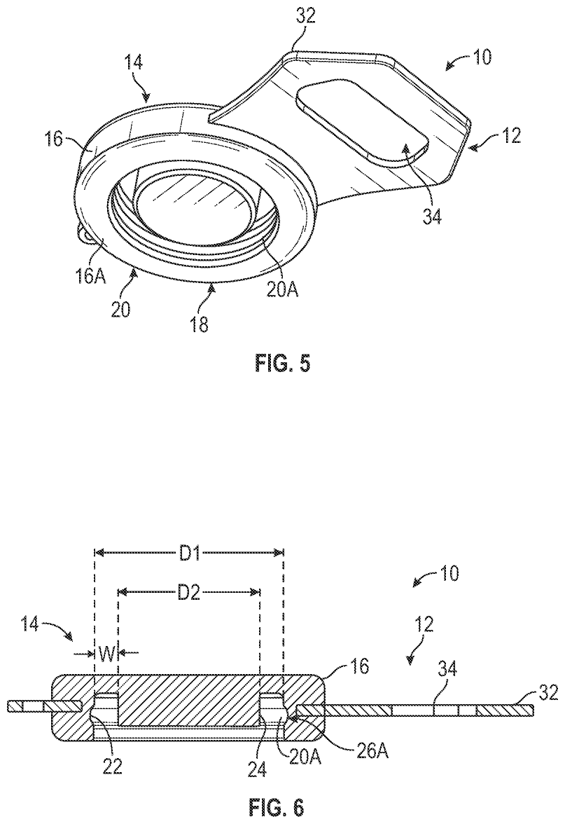

The second wall 24 may be vertical in nature. The diameter “D2” of the second wall 24 may be similar in size to an inner diameter “T” of the opening 2 in the beverage bottle 4. In accordance with the embodiment shown in FIGS. 2 and 3, a cavity 30 may be formed in a center area of the bottom surface 16A of the body member 16. The cavity 30 may allow the second wall 24 to form a ring. Alternatively, as may be seen in FIGS. 5 and 6, the center area of the bottom surface 16A of the body member 16 may remain as a solid member.

The bottle opening member 12 may be attached to the cap 14. The bottle opening member 12 may be formed of a strong and lightweight material. For example, a metal such as aluminum or similar materials may be used. The bottle opening member 12 may be formed of a leg member 32 which extends out from the cap 14. Located at a distal end of the leg member 32 may be a slot 34. The slot 34 may have a width similar in size to a bottle cap used to cover the top opening in the beverage bottle.

In operation, the user may first use the combination bottle opener and cover 10 to remove a bottle cap from the beverage bottle 4. To do so, the user may position the bottle cap within the slot 34 of the bottle opening member 12. The bottle cap may be positioned such that a bottom edge of the bottle cap rest against one edge of the slot 34. A top of the bottle cap may be positioned on an opposing edge of the slot 34. A pulling motion on the leg member 32 may cause the bottom edge of the bottle cap to pull up and away from the lip 28 formed around the opening 2 in the beverage bottle 4 thereby separating the bottle cap from the beverage bottle 4.

Once the bottle cap is removed, the user may insert the garnish 6 into the beverage bottle 4. The garnish 6 may be inserted into the opening 2 formed in the neck of the beverage bottle 4. Once the garnish 6 is placed within the beverage bottle 4, one may want to mix the garnish 6 with the beverage 8 stored in the beverage bottle 4. To mix the garnish 6, one may place the bottle sealer 18 over the opening 2. The bottle sealer 18 is positioned over the opening 2 such that the top of the lip 28 formed on the opening 2 is inserted into the circular groove 20A of the bottle sealer 18. The indentation 27 formed on the first wall 22 of the circular groove 20A engages with a depth “D” of the lip 28 and the second wall 24 is inserted into opening 2 engaging the interior wall of the opening 2 thereby securing the bottle sealer 18 to the opening 2. The user may place a finger/thumb on top of the bottle sealer 18 positioned over the opening 2 and turn the beverage bottle 4 upside down and then back right-side up thereby mixing the mix the garnish 6 with the beverage 8 stored in the beverage bottle 4. When the beverage bottle 4 is turned upside down and then back right-side up, gaseous molecules may be formed within the beverage 8 stored in the beverage bottle 4 causing a build-up of gaseous pressure within the beverage bottle 4. When the user removes his/her finger/thumb from the top of the bottle sealer 18, the gas pressure pushes up on the bottle sealer 18 causing the second wall 24 to contract away from the lip 28 on the opening 2. This may cause the combination bottle opener and cover 10 to pop off the lip 28 of the opening 2 gradually releasing the gas pressure within the beverage bottle 4. The gradual release of the gas pressure prevents the beverage 8 from foaming out of the opening 2.

While embodiments of the disclosure have been described in terms of various specific embodiments, those skilled in the art will recognize that the embodiments of the disclosure may be practiced with modifications within the spirit and scope of the claims

What is claimed is:

1. A combination bottle opener and cover comprising:
a bottle opening member; and
a cap, wherein the cap comprises:
a body member, the body member having a circular groove formed on a bottom surface of the body member, the circular groove having a width “W” equal in size to the width “L” of a lip formed around a top opening in a beverage bottle.

2. The combination bottle opener and cover of claim 1, wherein the cap is formed of a pliable material.

3. The combination bottle opener and cover of claim 1, wherein the cap is formed of plastic, rubber and like materials.

4. The combination bottle opener and cover of claim 1, wherein the circular groove comprises:
a first wall formed around a diameter “D1” of the body member;
a second wall formed around a diameter “D2” of the body member wherein the diameter “D1” is larger in size that “D2” forming the circular groove; and
a “U” shaped indentation formed around a perimeter of the first wall.

5. The combination bottle opener and cover of claim 4, wherein the “U” shaped indentation has a depth equal in size to a depth “D” of the lip.

6. The combination bottle opener and cover of claim 4, wherein a cavity is formed in a center area of the bottom surface of the body member, the cavity configuring the second wall into a ring.

7. The combination bottle opener and cover of claim 1, wherein the bottle opening member is attached to the cap.

8. The combination bottle opener and cover of claim 1, wherein the bottle opening member comprises:
a leg member which extends out from the cap; and
a slot formed at a distal end of the leg member.

9. The combination bottle opener and cover of claim 1, wherein the bottle opening member is formed of metal.

10. A combination bottle opener and cover comprising:
a bottle opening member; and
a cap coupled to the bottle opening member, wherein the cap comprises:
a body member, the body member having a circular groove formed on a bottom surface of the body member, the circular groove having a width “W” equal in size to the width “L” of a lip formed around a top opening in a beverage bottle, wherein the circular groove comprises:
a first wall formed around a diameter “D1” of the body member;
a second wall formed around a diameter “D2” of the body member wherein the diameter “D1” is larger in size that “D2” forming the circular groove; and
a “U” shaped indentation formed around a perimeter of the first wall.

11. The combination bottle opener and cover of claim 10, wherein the “U” shaped indentation has a depth equal in size to a depth “D” of the lip.

12. The combination bottle opener and cover of claim 10, wherein the cap is formed of a pliable material.

13. The combination bottle opener and cover of claim 10, wherein the cap is formed of plastic, rubber and like materials.

14. The combination bottle opener and cover of claim 10, wherein a cavity is formed in a center area of the bottom surface of the body member, the cavity configuring the second wall into a ring.

15. The combination bottle opener and cover of claim 10, wherein the bottle opening member is attached to the cap.

16. The combination bottle opener and cover of claim 10, wherein the bottle opening member comprises:
a leg member which extends out from the cap; and
a slot formed at a distal end of the leg member.

17. The combination bottle opener and cover of claim 10, wherein the bottle opening member is formed of metal.

18. A combination bottle opener and cover comprising:
a bottle opening member; and
a cap directly attached to the bottle opening member, wherein the cap is formed of a pliable material and comprises:
a body member, the body member having a circular groove formed on a bottom surface of the body member, the circular groove having a width “W” equal in size to the width “L” of a lip formed around a top opening in a beverage bottle, wherein the circular groove comprises:
a first wall formed around a diameter “D1” of the body member;
a second wall formed around a diameter “D2” of the body member wherein the diameter “D1” is larger in size that “D2” forming the circular groove; and
a “U” shaped indentation formed around a perimeter of the first wall, wherein the “U” shaped indentation has a depth equal in size to a depth “D” of the lip;
wherein the bottle opening member comprises:
a leg member which extends out from the cap; and
a slot formed at a distal end of the leg member.

19. The combination bottle opener and cover of claim 18, wherein the cap is formed of plastic, rubber and like materials.

20. The combination bottle opener and cover of claim 18, wherein a cavity is formed in a center area of the bottom surface of the body member, the cavity configuring the second wall into a ring.
